(19) United States
(12) Patent Application Publication
(10) Pub. No.: US 2015/0186034 A1
(43) Pub. Date: Jul. 2, 2015

(54) RECOGNITION SYSTEM AND METHOD FOR RECOGNIZING HANDWRITING FOR ELECTRONIC DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: HAI-SHENG LI, Shenzhen (CN); CHIH-SAN CHIANG, New Taipei (TW); HUI-GANG HE, Shenzhen (CN); YU-DA XU, Shenzhen (CN)

(21) Appl. No.: 14/584,011

(22) Filed: Dec. 29, 2014

(30) Foreign Application Priority Data
Dec. 31, 2013 (CN) 201310749003.0

(51) Int. Cl. G06F 3/0488; G06K 9/72; G06K 9/62

(52) U.S. Cl. CPC G06F 3/04883; G06K 9/6217; G06K 9/72

(57) ABSTRACT

A recognition system and method for recognizing handwriting on an electronic device are provided. The recognition system includes a processor configured to execute instructions stored in a memory for: creating handwriting in response to a handwriting input; displaying the created handwriting on a user interface of the electronic device; defining a first planar coordinate system on the user interface; determining the electronic device is rotated if a rotation angle is larger than a predetermined value; defining a second planar coordinate system on the user interface; identifying a coordinate of each touched point of the handwriting in the second planar coordinate system; recognizing the handwriting according to the coordinate and retrieving one or more first characters or words matching the handwriting; and displaying the retrieved one or more first characters or words on the user interface.

### CROSS-REFERENCE TO RELATED APPLICATIONS

This application claims priority to Chinese Patent Application No. 201310749003.0 filed on Dec. 31, 2013, the contents of which are incorporated by reference herein.

### FIELD

The subject matter herein generally relates to recognition systems for recognizing handwriting, and particularly to a recognition system for recognizing handwriting for electronic devices.

### BACKGROUND

Electronic devices having handwriting input functions are widely used in many fields. These electronic devices recognize handwriting input by a user and display one or more words and/or one or more characters matching the input handwriting.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an electronic device applying a recognition system for recognizing handwriting for the electronic device.

FIG. 2 is a user interface shown on an electronic device running the recognition system of FIG. 1.

FIG. 3 is diagrammatic view showing the electronic device of FIG. 2 which has been rotated and displays a user interface thereon.

FIG. 4 shows a first planar coordinate system created by a first coordinate defining unit of the electronic device of FIG. 1.

FIG. 5 shows a second planar coordinate system created by a second coordinate defining unit of the electronic device of FIG. 1.

FIG. 6 is the electronic device showing in FIG. 3, but displaying another user interface.

FIG. 7 shows an electronic device of FIG. 2 displaying a user interface.

FIG. 8 is a flowchart of an embodiment of a method for recognizing handwriting for an electronic device, such as the one of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have noten described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The word “module,” and “unit” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

The present disclosure is described in relation to a recognition system and method for recognizing handwriting on an electronic device. The recognition system includes a processor configured to execute instructions stored in a memory for: creating handwriting in response to a handwriting input; displaying the created handwriting on a user interface of the electronic device; defining a first planar coordinate system on the user interface; determining the electronic device is rotated if a rotation angle is larger than a predetermined value; defining a second planar coordinate system on the user interface; identifying a coordinate of each touched point of the handwriting in the second planar coordinate system; recognizing the handwriting according to the coordinate and retrieving one or more first characters or words matching the handwriting; and displaying the retrieved one or more first characters or words on the user interface.

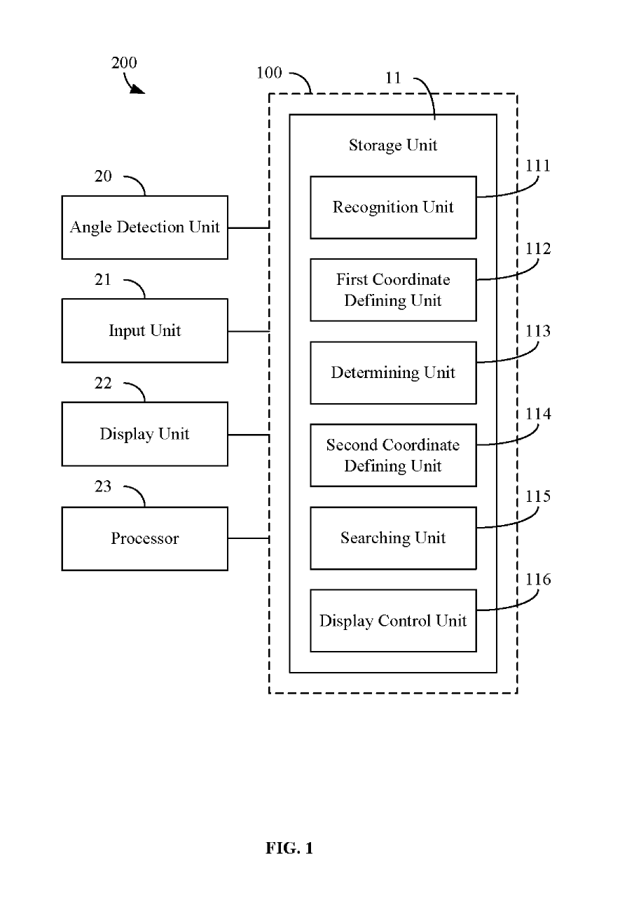

FIG. 1 illustrates an embodiment of an electronic device 200. A recognition system 100 is applied to the electronic device 200. The electronic device 200 can be a mobile phone or a tablet computer. The electronic device 200 can include an angle detection unit 20, an input unit 21 and a display unit 22. The electronic device 200 can also include at least one processor 23 and a storage unit 11. In at least one embodiment, the electronic device 200 includes one processor 23. The processor 23 executes instructions of a plurality of units stored in the storage unit 11. The storage unit 11 can store a recognition unit 111, a first coordinate defining unit 112, a determining unit 113, a second coordinate defining unit 114, a searching unit 115 and a display control unit 116.

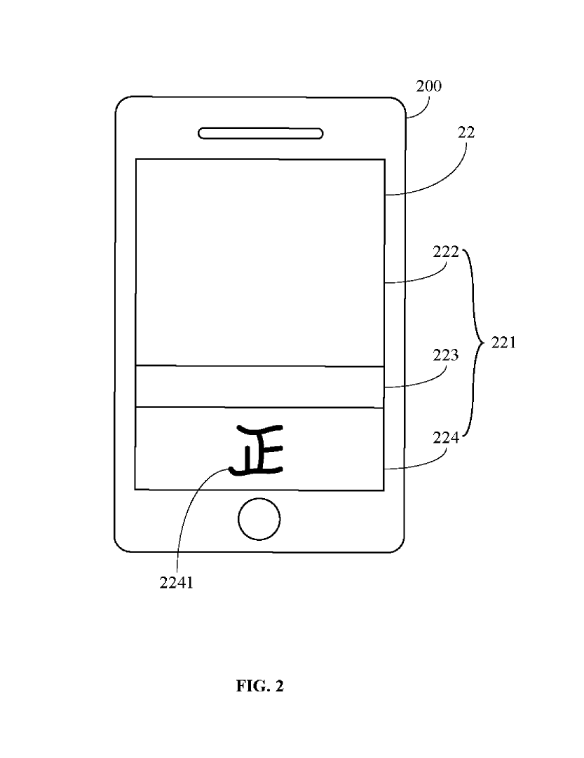

The display unit 22 displays a user interface 221 shown in FIG. 2. The user interface 221 can include a text display region 222, a search display region 223 and an input display region 224.

The input unit 21 detects a plurality of touched points of input handwriting 2241. In at least one embodiment, the input unit can be a touch panel which is mounted on the display unit 22.

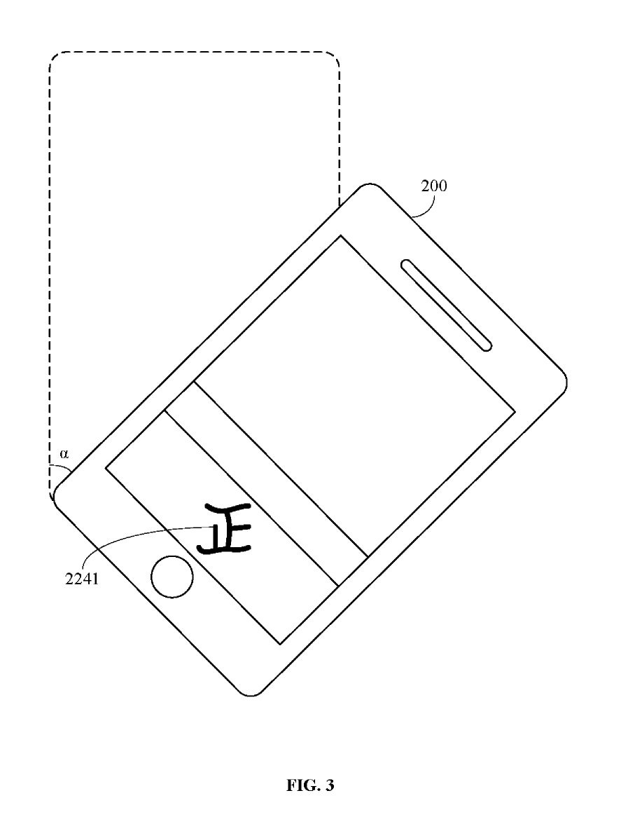

The angle detection unit 20 detects a rotation angle of the electronic device 200 and transmits the detected rotation angle information to the processor 23. The rotation angle α (shown in FIG. 3) is an angle between a vertical axis associated with a current position of the electronic device 200 (e.g. shown in FIG. 3) and a vertical axis associated with a vertical position of the electronic device 200 (e.g. shown in FIG. 2). In at least one embodiment, the angle detection unit 20 can be a gravity sensor; the gravity sensor detects an acceleration caused by gravity, and calculates the rotation angle according to the acceleration. In other embodiments, the angle detection unit 20 can be a gyro-sensor.

The recognition unit 121 creates the handwriting 2241 in response to a handwriting input operation by the user, and the display control unit 116 controls the display unit 22 to display the created handwriting 2241 on the input display region 224. The handwriting 2241 indicates information of locations of points touched by the user.

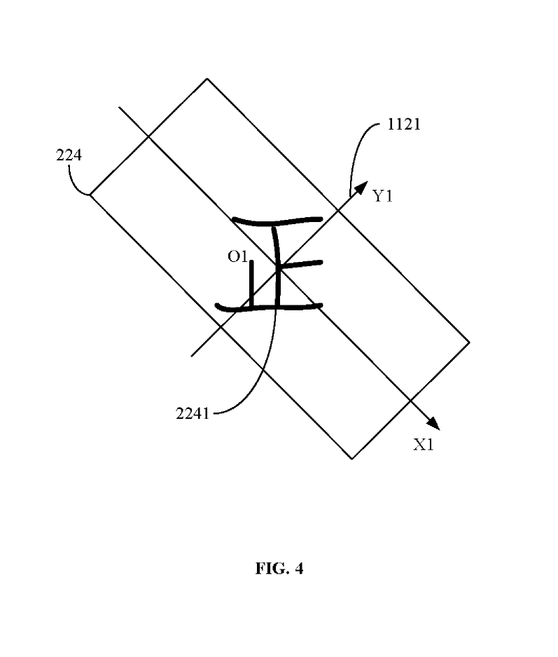

The first coordinate defining unit 112 defines a first planar coordinate system 1121 shown in FIG. 4 on the input display region 224. In at least one embodiment, an origin O1 of the first planar coordinate system 1121 is on the center of the input display region 224. The axis X1 of the first planar coordinate system 1121 extends along a width of the electronic device 200. The axis Y1 of the first planar coordinate system 1121 extends along a length of the electronic device 200. Each touched point of the handwriting 2241 has a first coordinate (X1, Y1) in the first planar coordinate system 1121.

The determining unit 113 determines whether the electronic device 200 is rotated according to the rotation angle. In at least one embodiment, the determining unit 113 determines the electronic device 200 is rotated if the rotation angle of the electronic device 200 is larger than a predetermined value, for example 5 degrees; otherwise, the determining unit 113 determines the electronic device 200 is not rotated if the rotation angle of the electronic device 200 is smaller than the predetermined value.

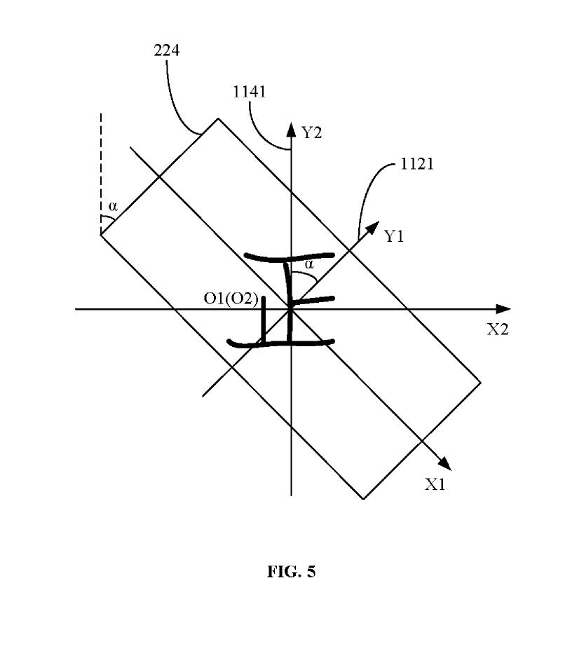

The second coordinate defining unit 114 defines a second planar coordinate system 1141 shown in FIG. 5 on the input display region 224. Each touched point of the handwriting 2241 has a second coordinate when the electronic device 200 is determined by the determining unit 113 to be rotated. In at least one embodiment, the rotation angle is α, an origin O2 of the second planar coordinate system 1141 is overlapping with the origin O1 of the first planar coordinate system 1121. The axis X2 of the second planar coordinate system 1141 has an angle α, which is opposite to a rotation direction of the electronic device 200, relating to the axis X1 of the first planar coordinate system 1121. The axis Y2 of the second planar coordinate system 1141 is an axis which has an angle α, which is opposite to the rotation direction of the electronic device 200, relating to the axis Y2 of the first planar coordinate system 1121. Each touched point of the handwriting 2241 has the second coordinate (X2, Y2) in the second planar coordinate system 1141.

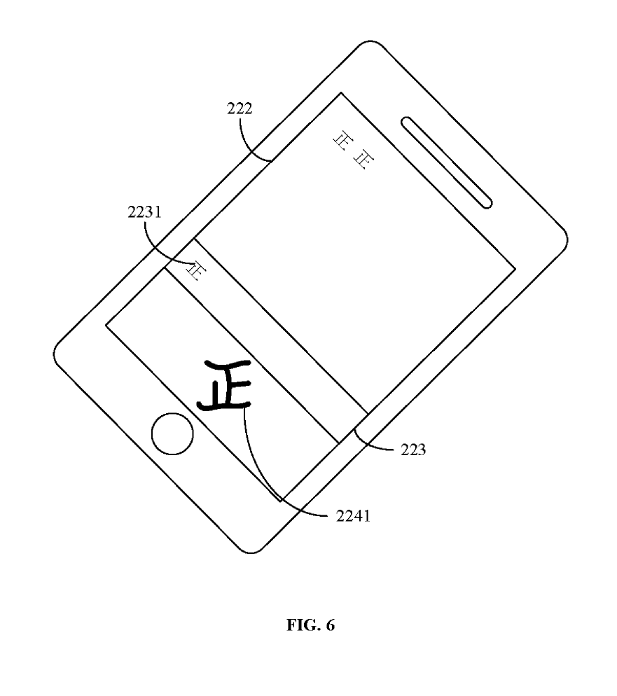

The storage unit 11 stores a database recording a number of characters and a number of words. If the determining unit 113 determines that the electronic device 200 is rotated, the searching unit 115 recognizes the handwriting 2241 according to the second coordinate of each touched point of the handwriting 2241 and retrieves one or more first characters (or words) 2231, shown in FIG. 6, which match the handwriting 2241, in the database. The display control unit 116 controls the display unit 22 to display the retrieved one or more first characters (or words) 2231 on the search display region 223 for the user to select.

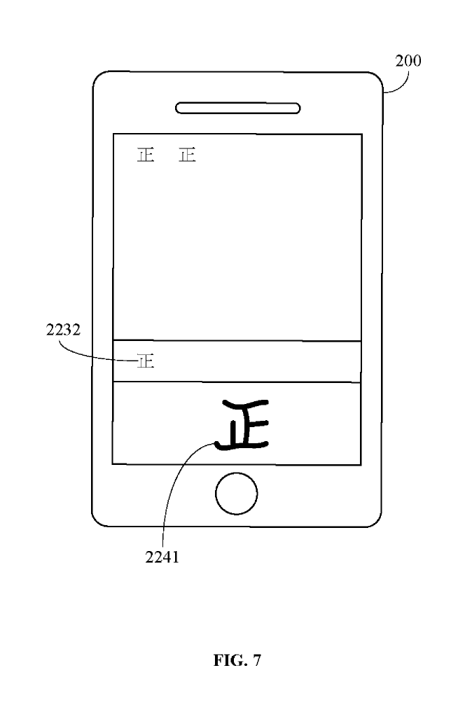

If the determining unit 113 determines that the electronic device 200 is not rotated, the searching unit 115 recognizes the handwriting 2241 according to the first coordinate of each touched point of the handwriting 2241 and retrieves one or more second characters (or words) 2232, shown in FIG. 7, which match the handwriting 2241, in the database. The display control unit 116 controls the display unit 22 to display the retrieved one or more second characters (or words) 2232 on the search display region 223 for the user to select.

If one of the retrieved one or more first characters (or words) 2231 or one or more second characters (or words) 2232 is selected by the user, the display control unit 116 controls the display unit 22 to display the selected character (or word) on the text display region 222.

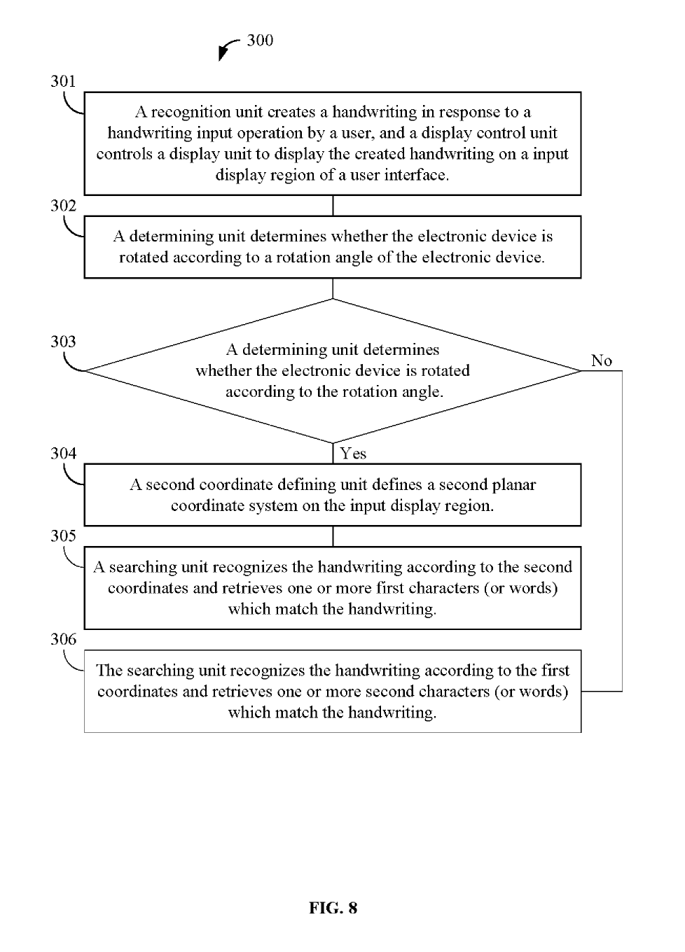

Referring to FIG. 8, a flowchart is presented in accordance with an example embodiment. A method 300 is provided by way of example, as there are a variety of ways to carry out the method. The method 300 described below can be carried out using the configurations illustrated in FIG. 1 and various elements of these figures are referenced in explaining example method 300. Each block shown in FIG. 8 represents one or more processes, methods, or routines, carried out in the exemplary method 300. Additionally, the illustrated order of blocks is by example only and the order of the blocks can be changed. The exemplary method 300 can begin at block 301.

At block 301, a recognition unit creates handwriting in response to handwriting input operation by a user, and a display control unit controls a display unit to display the created handwriting on a input display region of a user interface. The handwriting indicates information of locations of points touched by the user.

At block 302, a first coordinate defining unit defines a first planar coordinate system on an input display region of the user interface. In at least one embodiment, an electronic device has a rectangular obverse side, an origin O1 of the first planar is on the center of the input display region. The axis X1 of the first planar coordinate system extends along a width of the electronic device. The axis Y1 of the first planar coordinate system extends along a length of the electronic device. Each touched point of the handwriting is defined as a first coordinate (X1,Y1) in the first planar coordinate system.

At block 303, a determining unit determines whether the electronic device is rotated according to a rotation angle of the electronic device. In at least one embodiment, the determining unit determines the electronic device is rotated if the rotation angle of the electronic device is larger than a predetermined value, for example 5 degrees, and the process goes to block 304; otherwise, the determining unit determines the electronic device is not rotated if the rotation angle of the electronic device is smaller than the predetermined value, and the process goes to 306.

At block 304, a second coordinate defining unit defines a second planar coordinate system on the input display region and defines each touched point of the handwriting as a second coordinate. In at least one embodiment, the rotation angle is α, an origin O2 of the second planar coordinate system is overlapping with the origin O1 of the first planar coordinate system. The axis X2 of the second coordinate system has an angle α, which is opposite to a rotation direction of the electronic device, relating to the axis X1 of the first planar coordinate system. The axis Y2 of the second planar coordinate system has an angle α, which is opposite to the rotation direction of the electronic device, relating to the axis Y1 of the first planar coordinate system. Each touched point of the handwriting is defined as the second coordinate (X2,Y2) in the second planar coordinate system.

At block 305, a searching unit recognizes the handwriting according to the second coordinate of each touched point of the handwriting and retrieves one or more first characters (or words) which match the handwriting, in a database stored in a storage unit. The display control unit controls the display unit to display the retrieved one or more first characters (or words) on a search display region of the user interface for the user to select. If one of the retrieved one or more first characters (or words) is selected by the user, the display control unit controls the display unit to display the selected character (or word) on a text display region of the user interface.

At block 306, the searching unit recognizes the handwriting according to the first coordinate of each touched point of the handwriting and retrieves one or more second characters (or words) which match the handwriting, in a database stored in a storage unit. The display control unit controls the display unit to display the retrieved one or more second characters (or words) on the search display region of the user interface for the user to select. If one of the retrieved one or more second characters (or words) is selected by the user, the display control unit controls the display unit to display the selected character (or word) on a text display region of the user interface.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A recognition system for recognizing handwriting on an electronic device, the recognition system comprising a plurality of units stored in a storage unit which can be executed by a processor to:
create handwriting in response to a handwriting input applied on and detected by an input unit;
display the handwriting on a user interface of the electronic device;
define a first planar coordinate system on the user interface;
determine that the electronic device is rotated if a rotation angle is larger than a predetermined value;
define a second planar coordinate system on the user interface based on the rotation angle of the electronic device and the first planar coordinate system;
identify a coordinate of each touched point of the handwriting in the second planar coordinate system;
recognize the handwriting according to the coordinate of each touched point of the handwriting and retrieve one or more first characters or words matching the handwriting; and
display the one or more first characters or words on the user interface.

2. The recognition system of claim 1, wherein the recognition system further comprising a plurality of units stored in the storage unit which can be executed by the processor to:
identify another coordinate of each touched point of the handwriting in the first planar coordinate system;
determine the electronic device is not rotated when the rotation angle is smaller than the predetermined value;
recognize the handwriting according to the another coordinate of each touched point of the handwriting and retrieve one or more second characters or words matching the handwriting; and
display the one or more second characters or words on the user interface.

3. The recognition system of claim 1, wherein an origin of the first planar coordinate system is on the center of an input display region of the user interface, the horizontal axis of the first planar coordinate system extends along a width of the electronic device, the vertical axis of the first planar coordinate system extends along a length of the electronic device.

4. The recognition system of claim 3, wherein an origin of the second planar coordinate system is overlapped with the origin of the first planar coordinate system, the horizontal axis of the second coordinate system has an angle of the rotation angle relating to the horizontal axis of the first planar coordinate system, the vertical axis of the second planar coordinate system has an angle of the rotation angle relating to the vertical axis of the first planar coordinate system.

5. A recognition method for recognizing handwriting on an electronic device, the recognition method comprising:
executing a plurality of units stored in a storage unit by a processor for:
creating handwriting in response to handwriting input applied on and detected by an input unit;
displaying the recognized handwriting on a user interface of the electronic device;
defining a first planar coordinate system on the user interface;
determining that the electronic device is rotated if a rotation angle is larger than a predetermined value;
defining a second planar coordinate system on the user interface based on the rotation angle of the electronic device and the first planar coordinate system;
identifying a coordinate of each touched point of the handwriting in the second planar coordinate system;
recognizing the handwriting according to the coordinate of each touched point of the handwriting and retrieving one or more first characters or words matching the handwriting; and
displaying the one or more first characters or words on the user interface.

6. The recognition method of claim 5, wherein the recognition method further comprising a plurality of units stored in the storage unit which can be executed by the processor for:
identifying another coordinate of each touched point of the handwriting in the first planar coordinate system;
determining the electronic device is not rotated when the rotation angle is smaller than the predetermined value;
recognizing the handwriting according to the another coordinate of each touched point of the handwriting and retrieving one or more second characters or words matching the handwriting; and
displaying the one or more second characters or words on the user interface.

7. The recognition method of claim 5, wherein defining a first planar coordinate system on the user interface comprising:
defining an origin on the center of an input display region of the user interface;
defining an horizontal axis along a width of the electronic device; and
defining an vertical axis along a length of the electronic device.

8. The recognition method of claim 7, wherein defining a second planar coordinate system on the user interface based on the rotation angle of the electronic device and the first planar coordinate system comprising:
defining an origin on the center of the input display region;
defining an horizontal axis which has an angle of the rotation angle relating to the horizontal axis of the first coordinate system; and
defining an vertical axis which has an angle of the rotation angle relating to the vertical axis of the first coordinate system.
